(19) United States
(12) Patent Application Publication
(10) Pub. No.: US 2024/0039036 A1
(43) Pub. Date: Feb. 1, 2024

(54) FLEXIBLE SOLID ELECTROLYTE MEMBRANE FOR ALL-SOLID-STATE BATTERY, ALL-SOLID-STATE BATTERY COMPRISING THE SAME, AND MANUFACTURING METHOD THEREOF

(71) Applicants: Hyundai Motor Company, Seoul (KR); Kia Corporation, Seoul (KR); Ulsan National Institute of Science and Technology, Ulsan (KR)

(72) Inventors: Hoon Seok, Suwon-Si (KR); Yeong Jun Cheon, Daegu (KR); Hong Seok Min, Yongin-Si (KR); Sang Young Lee, Ulsan (KR); Kyeong Seok Oh, Ulsan (KR); Yong Hyeok Lee, Ulsan (KR)

(21) Appl. No.: 18/085,996

(22) Filed: Dec. 21, 2022

(30) Foreign Application Priority Data
Jul. 28, 2022 (KR) 10-2022-0093978

(51) Int. Cl. H01M 10/056; H01M 10/44; H01M 10/0585

(52) U.S. Cl. CPC H01M 10/056; H01M 10/446; H01M 10/0585

(57) ABSTRACT

A flexible self-supporting solid electrolyte membrane, an all-solid-state battery including the membrane, and a manufacturing method thereof are disclosed. The solid electrolyte membrane may include: a substrate including pores therein; and a solid electrolyte layer disposed on at least one surface of the substrate and including a solid electrolyte and a cured compound. At least a portion of the solid electrolyte layer may penetrate into the pores of the substrate to form a conduction path of lithium ions in a thickness direction of the substrate.

### CROSS-REFERENCE TO RELATED APPLICATION

This application claims under 35 U.S.C. § 119(a) the benefit of priority to Korean Patent Application No. 10-2022-0093978 filed on Jul. 28, 2022, the entire contents of which are incorporated herein by reference.

### BACKGROUND

### (a) Technical Field

The present disclosure relates to a flexible self-supporting solid electrolyte membrane, an all-solid-state battery including the same, and a manufacturing method thereof.

### (b) Discussion of the Background

Lithium secondary batteries have been developed as small power sources for smartphones and small electronic devices, etc., and their demand has increased in accordance with the development of electric vehicles.

A lithium secondary battery includes cathode materials and anode materials capable of exchanging lithium ions, as well as an electrolyte conducting lithium ions. A typical lithium secondary battery uses a liquid electrolyte in which a lithium salt is dissolved in an organic solvent, and includes a separator made of organic fibers to prevent physical contact between a cathode and an anode. Since a flammable organic solvent is used as an electrolyte solvent, there is a high possibility of fire and explosion in the event of a short circuit (e.g., due to a physical damage), and in fact, many fire incidents occur.

In an all-solid-state battery, a flammable liquid electrolyte is replaced with an inorganic solid electrolyte. As inorganic solid electrolytes, oxide-based solid electrolytes and sulfide-based solid electrolytes are mainly used. Among them, sulfide-based solid electrolytes are promising because of their high lithium ion conductivity close to that of liquid electrolytes.

However, the sulfide-based solid electrolyte has some disadvantages (e.g., their mechanical properties are poor), and thus processability and battery stability are degraded. On a small scale, a solid electrolyte in a powder form may be pressured and used in a pellet form. However, a solid electrolyte membrane in a sheet form may be required for mass production and the mechanical properties of the sheet should be capable of withstanding a process.

Further, it may be difficult to secure processability because the sulfide-based solid electrolyte is fragile when pressure is applied. To address this problem, a method of coating a sulfide-based solid electrolyte together with a separator used in lithium-ion batteries may be used, but due to the added resistance of the separator, excellent lithium ion conductivity of the sulfide-based solid electrolyte may be offset or compromised. Also, it may be difficult to reduce the thickness of an entire film below a certain level because the thickness of the separator may not be reduced, and the performance of the solid electrolyte may be affected by using a solvent for coating. Meanwhile, a self-supporting film including a sulfide-based solid electrolyte may be manufactured by using a binder dissolved in a solvent. However, since the sulfide-based solid electrolyte has poor chemical stability, the lithium ion conductivity of the sulfide-based solid electrolyte may be reduced by the solvent.

### SUMMARY

The following summary presents a simplified summary of certain features. The summary is not an extensive overview and is not intended to identify key or critical elements.

An object of the present disclosure is to provide a flexible and unbreakable self-supporting solid electrolyte membrane.

Another object of the present disclosure is to provide a self-supporting solid electrolyte membrane having a thin thickness.

Still another object of the present disclosure is to provide a self-supporting solid electrolyte membrane having excellent lithium ion conductivity.

The objects of the present disclosure are not limited to the above-mentioned objects. The objects of the present disclosure will become more apparent from the following description, and will be implemented by the means described in the claims and combinations thereof.

A solid electrolyte membrane for an all-solid-state battery may include: a substrate including pores therein; and a solid electrolyte layer disposed on at least one surface of the substrate and including a solid electrolyte and a cured compound, wherein at least a portion of the solid electrolyte layer may penetrate into the pores of the substrate, and the solid electrolyte is filled in the pores of the substrate.

The solid electrolyte may be filled in the substrate based on a thickness direction of the substrate to form a conduction path of lithium ions in the substrate.

The solid electrolyte may include a sulfide-based solid electrolyte.

The cured compound may be derived from a monomer including at least one selected from the group consisting of a triacrylate-based monomer, a diacrylate-based monomer, a monoacrylate-based monomer, and combinations thereof.

The cured compound may be derived from a monomer having a viscosity of about 20 cP to 100 cP.

The solid electrolyte layer may include the solid electrolyte and the cured compound at a weight ratio of about 95:5 to 98:2.

The solid electrolyte membrane may have a thickness of about 20 μm to 30 μm.

An all-solid-state battery according to an exemplary embodiment of the present disclosure may include: the solid electrolyte membrane; a cathode disposed on one surface of the solid electrolyte membrane; and an anode disposed on another surface of the solid electrolyte membrane.

A manufacturing method of an all-solid-state battery may include: preparing a slurry including a solvent, a solid electrolyte, and a monomer; forming a coating layer by applying and drying the slurry on at least one surface of a substrate including pores therein; curing the coating layer to obtain a solid electrolyte membrane including the substrate and a solid electrolyte layer disposed on at least one surface of the substrate, wherein the solid electrolyte layer may comprise the solid electrolyte and a cured compound; and manufacturing an all-solid-state battery including the solid electrolyte membrane, a cathode disposed on one surface of the solid electrolyte membrane, and an anode disposed on another surface of the solid electrolyte membrane.

The solvent may have a vapor pressure of about 1 hPa or less.

The solvent may include hexyl butyrate.

The monomer may include at least one selected from the group consisting of a triacrylate-based monomer, a diacrylate-based monomer, a monoacrylate-based monomer, and combinations thereof.

The monomer may have a viscosity of about 20 cP to 100 cP.

The slurry may include an amount of about 40% to 55% by weight of the solid electrolyte and the monomer, and an amount of about 45% to 60% by weight of the solvent.

The coating layer may be cured by irradiating ultraviolet rays.

The all-solid-state battery may be manufactured by laminating a plurality of solid electrolyte membranes and pressurizing the plurality of solid electrolyte membranes at a pressure of about 50 MPa to 100 MPa to obtain a laminate, and attaching the cathode and the anode to both surfaces of the laminate, respectively. The plurality of solid electrolyte membranes may comprise the solid electrolyte membrane.

The all-solid-state battery may be charged and discharged in a pressurized state at a pressure of about 200 MPa to 400 MPa.

According to the present disclosure, it is possible to obtain a flexible, unbreakable, self-supporting solid electrolyte membrane.

According to the present disclosure, it is possible to obtain a self-supporting solid electrolyte membrane having a thin thickness.

According to the present disclosure, it is possible to obtain a self-supporting solid electrolyte membrane having excellent lithium ion conductivity.

The effects of the present disclosure are not limited to the above-mentioned effects. It should be understood that the effects of the present disclosure includes all effects that can be inferred from the following descriptions.

### BRIEF DESCRIPTION OF THE DRAWINGS

FIG. 1 shows an example all-solid-state battery according to the present disclosure.

FIG. 2 shows an example all-solid-state battery according to the present disclosure.

FIG. 3 shows a solid electrolyte membrane according to the present disclosure.

FIG. 4A shows a solid electrolyte membrane according to Preparation Example 1.

FIG. 4B shows a result of 100 times of performing a folding test in which the solid electrolyte membrane according to Preparation Example 1 is folded at 180°.

FIG. 5A shows a solid electrolyte membrane according to Preparation Example 2.

FIG. 5B shows a result of 100 times of performing a folding test in which the solid electrolyte membrane according to Preparation Example 2 is folded at 180°.

FIG. 6 shows a result of charging and discharging an all-solid-state battery according to Example 1.

FIG. 7 shows a result of charging and discharging an all-solid-state battery according to Comparative Example 1.

FIG. 8 shows a result of charging and discharging an all-solid-state battery according to Comparative Example 2.

FIG. 9A shows a solid electrolyte membrane according to Preparation Example 3.

FIG. 9B shows a result of 100 times of performing a folding test in which the solid electrolyte membrane according to Preparation Example 3 is folded at 180°.

FIG. 10A shows a solid electrolyte membrane according to Preparation Example 4.

FIG. 10B shows a result of 100 times of performing a folding test in which the solid electrolyte membrane according to Preparation Example 4 is folded at 180°.

FIG. 11 shows a solid electrolyte membrane according to a Comparative Preparation Example.

FIG. 12 shows a result of charging and discharging an all-solid-state battery according to Example 2

### DETAILED DESCRIPTION

The above objects, other objects, features, and advantages of the present disclosure will be easily understood through the following examples related to the accompanying drawings. Aspects of the present disclosure, however, are not limited to the examples described herein and may also be embodied in other forms. Rather, various examples described herein are provided to make disclosed contents thorough and complete and sufficiently transfer the spirit of the present disclosure to those skilled in the art.

It should be understood that terms such as “comprise” or “have” as used herein, specify the presence of features, numerals, steps, operations, components, parts described herein, or combinations thereof, but do not preclude the possibility of the presence or addition of one or more other features, numerals, steps, operations, components, parts, or combinations thereof. In addition, when a portion such as a layer, a film, a region, or a substrate, is referred to as being “on” another portion, a portion may be “directly on” another portion or the other portion may be present therebetween. In contrast, when an element such as a layer, a film, a region, or a substrate is referred to as being “under” another element, it can be “directly under” the other element or intervening elements may also be present.

It should be understood that all numbers, values, and/or expressions expressing quantities of components, reaction conditions, polymer compositions and formulations used in the present specification are approximate values obtained by reflecting various uncertainties of the measurement that arise in obtaining these values among others in which these numbers are essentially different. Therefore, they should be understood as being modified by the term “about” in all cases. In addition, when numerical ranges are disclosed in this description, such ranges are continuous and include all values from a minimum value to a maximum value inclusive of the maximum value of such ranges, unless otherwise indicated. Furthermore, when such ranges refer to an integer, all integers from the minimum value to the maximum value inclusive of the maximum value are included, unless otherwise indicated.

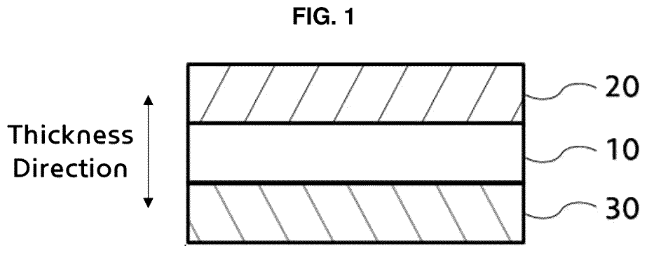

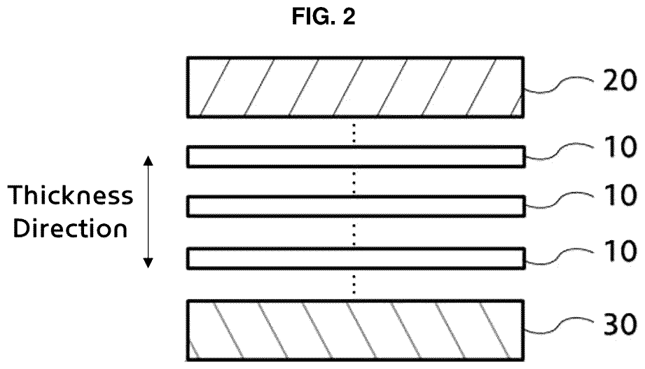

FIG. 1 shows an example all-solid-state battery according to the present disclosure. The all-solid-state battery may include a solid electrolyte membrane 10, a cathode 20 disposed on one surface of the solid electrolyte membrane 10, and an anode 30 disposed on the other surface of the solid electrolyte membrane 10. FIG. 2 shows an example all-solid-state battery according to the present disclosure. The all-solid-state battery may have a plurality of solid electrolyte membranes 10 stacked between the cathode 20 and the anode 30.

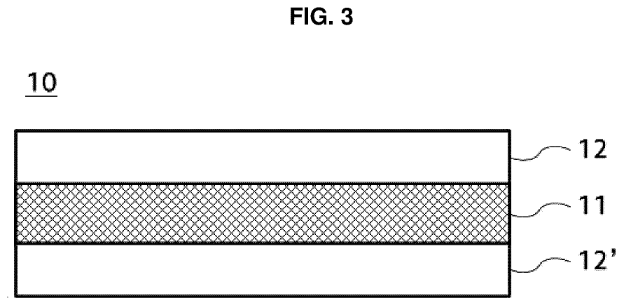

FIG. 3 shows a solid electrolyte membrane according to the present disclosure. The solid electrolyte membrane 10 may include a substrate 11 and a solid electrolyte layer 12 disposed on at least one surface of the substrate 11. FIG. 3 shows a solid electrolyte membrane in which solid electrolyte layers 12 and 12′ are formed on both surfaces of the substrate 11, but aspects of the present disclosure are not limited thereto. For example, a solid electrolyte layer 12 may be formed on only one surface of the substrate 11.

The substrate 11 may include a porous sheet including pores therein. For example, the substrate 11 may include a porous nonwoven fabric. The nonwoven fabric may comprise (e.g., be made of) a material such as polyethylene or polypropylene.

The solid electrolyte layer 12 may conduct lithium ions in the solid electrolyte membrane 10.

The solid electrolyte layer 12 may include a solid electrolyte and a cured compound. At least a portion of the solid electrolyte layer 12 may penetrate into the pores of the substrate 11. Accordingly, a solid electrolyte may be filled in the substrate 11 through the thickness direction of the substrate 11 to form a conduction path of lithium ions in the substrate 11.

The solid electrolyte may include a sulfide-based solid electrolyte. The sulfide-based solid electrolyte may include at least one selected from Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers; and Z is any one of Ge, Zn, Ga), Li₂S—GeS₂, Li₂S—SiS₂—Li₃PO₄, Li₂S—SiS₂-LiₓMO_{y} (where x and y are positive numbers, and M is any one of P, Si, Ge, B, Al, Ga, and In), Li₁₀GeP₂Si₂, etc.

The cured compound may prevent the solid electrolyte from falling off.

The cured compound may be obtained by curing a monomer including at least one selected from the group consisting of a triacrylate-based monomer, a diacrylate-based monomer, a monoacrylate-based monomer, and/or combinations thereof. As will be described later, in one or more examples of the present disclosure, a monomer may be used as a starting material for preparing the solid electrolyte layer 12 and the monomer may be cured during a production process. If a polymer or elastomer corresponding to the cured compound itself is used as a starting material to form the solid electrolyte layer 12, the starting material may be non-uniformly dispersed by causing aggregation of the solid electrolyte. During the drying process for forming the solid electrolyte layer 12, the solid electrolyte and the polymer may be randomly entangled to form the solid electrolyte layer 12 in an irregular structure.

The cured compound may be obtained by curing a monomer having a viscosity of about 20 cP to 100 cP. If the viscosity of the monomer is less than 20 cP, it may not be cured. On the other hand, if the viscosity of the monomer exceeds 100 cP, the viscosity may be too high to increase the content of the solid electrolyte, which may lead to degradation in the lithium ion conductivity of the solid electrolyte membrane 10.

The solid electrolyte layer 12 may include the solid electrolyte and the cured compound at a weight ratio of about 95:5 to 98:2. If the weight ratio of the cured compound is less than 2 (e.g., 99:1), the effect of preventing the solid electrolyte from falling off may be insignificant. If the weight ratio of the cured compound exceeds 5 (e.g., 94:6), the content of the solid electrolyte may be reduced, and thus the lithium ion conductivity of the solid electrolyte layer 10 may be degraded.

The solid electrolyte membrane 10 may have a thickness of about 20 μm to 30 μm. The all-solid-state battery (e.g., shown in FIG. 2) may include two or three solid electrolyte membranes 10 having a thickness of about 20 μm to 30 μm.

The cathode 20 may include a cathode active material, a solid electrolyte, a conductive material, etc.

The cathode active material may intercalate and deintercalate lithium ions. The cathode active material is not particularly limited, but may include, for example, an oxide active material or a sulfide active material.

The oxide active material may include a rock-salt-layer-type active material such as LiCoO₂, LiMnO₂, LiNiO₂, LiVO₂, Li₁₊ₓNi_{1/3}Co_{1/3}Mn_{1/3}O₂ or the like, a spinel-type active material such as LiMn₂O₄, Li(Ni_{0.5}Mn_{1.5})O₄ or the like, an inverse-spinel-type active material such as LiNiVO₄, LiCoVO₄ or the like, an olivine-type active material such as LiFePO₄, LiMnPO₄, LiCoPO₄, LiNiPO₄ or the like, a silicon-containing active material such as Li₂FeSiO₄, Li₂MnSiO₄ or the like, a rock-salt-layer-type active material in which a portion of a transition metal is substituted with a different metal, such as LiNi_{0.8}C_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one of Al, Mg, Co, Fe, Ni and Zn, 0<x+y<2), or lithium titanate such as Li₄Ti₅O₁₂ or the like.

The sulfide active material may include at least one of: copper sulfide, iron sulfide, cobalt sulfide, nickel sulfide, or the like.

The solid electrolyte may conduct lithium ions in the cathode 20. The solid electrolyte may include an oxide-based solid electrolyte or a sulfide-based solid electrolyte. However, it may be preferable to use a sulfide-based solid electrolyte having high lithium ion conductivity.

The sulfide-based solid electrolyte may include at least one of: Li₂S—P₂S₅, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers; and Z is any one of Ge, Zn, Ga), Li₂S—GeS₂, Li₂S—SiS₂—Li₃PO₄, Li₂S—SiS₂-LiₓMO_{y} (where x and y are positive numbers, and M is any one of P, Si, Ge, B, Al, Ga, and In), Li₁₀GeP₂S₁₂, etc.

The conductive material may form an electron conduction path within the electrode. The conductive material may include an spa carbon material such as carbon black, conductive graphite, ethylene black, carbon nanotube, etc., or graphene.

The anode 30 may include an anode active material and a solid electrolyte.

The anode active material is not particularly limited, but may include, for example, a carbon active material or a metal active material.

The carbon active material may include graphite such as mesocarbon microbead (MCMB) and highly oriented graphite (HOPG), and amorphous carbon such as hard carbon and soft carbon.

The metal active material may include at least one of: In, Al, Si, Sn, or an alloy containing at least one of these elements.

The solid electrolyte may conduct lithium ions in the anode 30. The solid electrolyte may include an oxide-based solid electrolyte or a sulfide-based solid electrolyte. However, it may be preferable to use a sulfide-based solid electrolyte having high lithium ion conductivity.

The sulfide-based solid electrolyte may include at least one of: Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers; Z is any one of Ge, Zn, Ga), Li₂S—GeS₂, Li₂S—SiS₂—Li₃PO₄, Li₂S—SiS₂—LiₓMO_{y} (where x and y are positive numbers, and M is any one of P, Si, Ge, B, Al, Ga, and In), Li₁₀GeP₂S₁₂, etc.

On the other hand, the anode 30 may include a lithium metal or a lithium metal alloy.

The lithium metal alloy may include an alloy of lithium and a metal capable of alloying with lithium or a metalloid. The metal capable of alloying with lithium or the metalloid may include Si, Sn, Al, Ge, Pb, Bi, Sb, etc.

The anode 30 may not include an anode active material and any component substantially performing the same role. When the all-solid-state battery is charged, lithium ions moved from the cathode 20 may be precipitated and stored in a form of lithium metal between the anode 30 and an anode current collector (not shown).

The anode 30 may include amorphous carbon and a metal capable of alloying with lithium.

The amorphous carbon may include at least one selected from the group consisting of furnace black, acetylene black, Ketjen black, graphene, and/or combinations thereof.

The metal may include at least one selected from the group consisting of gold (Au), platinum (Pt), palladium (Pd), silicon (Si), silver (Ag), aluminum (Al), bismuth (Bi), tin (Sn), zinc (Zn), and/or combinations thereof.

The manufacturing method of an all-solid-state battery may include: preparing a slurry including a solvent, a solid electrolyte, and a monomer; forming a coating layer by applying and drying the slurry on at least one surface of a substrate 11 including pores therein; curing the coating layer to obtain a solid electrolyte membrane 10; and manufacturing an all-solid-state battery including the solid electrolyte membrane 10, a cathode 20, and an anode 30.

In order to permeate the solid electrolyte layer 12 into the substrate 11, the type of solvent and a content of the solvent in the slurry may be important.

First, the solvent should not react with the solid electrolyte. This is to prevent loss of solid electrolyte due to side reactions. The solvent may be non-polar or very low in polarity. It may be preferred that the solvent should have an appropriate level of volatility. If the volatility of the solvent is too high, the solid electrolyte layer 12 is non-uniformly formed. The solvent may have a vapor pressure of about 1 hPa or less at about 20° C.

The solvent may include hexyl butyrate. The hexyl butyrate has very low polarity and has a vapor pressure of about 0.3 hPa at about 20° C.

As described above, the monomer may include at least one selected from the group consisting of a triacrylate-based monomer, a diacrylate-based monomer, a monoacrylate-based monomer, and/or combinations thereof.

The triacrylate-based monomer may include trimethylolpropane ethoxylate triacrylate (ETPTA).

The diacrylate-based monomer may include poly(ethylene glycol) diacrylate (PEGDA), 1,6-hexanediol diacrylate (HDDA), etc. The polyethylene glycol diacrylate is a derivative of poly(ethylene glycol), and is presented as a monomer of polymerized-poly(ethylene glycol) diacrylate in the present specification.

The monoacrylate-based monomer may include 2-(dimethylamino)ethyl methacrylate (DMAEMA).

The slurry may include an amount of about 40% to 55% by weight of the solid electrolyte and monomer, and an amount of about 45% to 60% by weight of the solvent. If the content of the solvent is less than 45% by weight, the viscosity of the slurry may be too high, and thus it may be difficult to uniformly form a coating layer on the substrate 11. On the other hand, if the content of the solvent exceeds 60% by weight, the slurry may be too thin to fill the pores of the substrate 11 and pass through the pores.

The coating layer may be formed by applying and drying the slurry on at least one surface of the substrate 11. Thereafter, the solid electrolyte layer 12 may be formed by curing the coating layer.

To form the solid electrolyte layer 12 on both surfaces of the substrate 11, a first coating layer may be formed on one surface of the substrate 11 and cured, and then a second coating layer may be formed on the other surface of the substrate 11 and cured.

Drying conditions of the slurry are not particularly limited as long as the solvent may be sufficiently dried. For example, the coating layer may be formed by applying the slurry on the substrate 11 and drying the slurry at about 80° C. to 100° C. for about 10 minutes to 1 hour.

The coating layer may be cured by irradiating ultraviolet rays. When the slurry is applied on the substrate 11, at least a portion of the slurry penetrates into the pores of the substrate 11. If a coating layer is formed by drying in the above-mentioned state, the lithium ion conductivity of the solid electrolyte membrane 10 is not degraded because the solid electrolyte is also present in the substrate 11. The coating layer may be cured to form a cured compound derived from the monomer, thereby preventing the solid electrolyte from being falling off.

An all-solid-state battery may be manufactured by attaching the cathode 20 and the anode 30 to both surfaces of the solid electrolyte membrane 10 obtained as described above.

On the other hand, as shown in FIG. 2, the all-solid-state battery including a plurality of solid electrolyte membranes 10 may be manufactured by laminating the solid electrolyte membranes 10 and pressurizing them at a pressure of about 50 MPa to 100 MPa to obtain a laminate, and attaching the cathode 20 and the anode 30 to both surfaces of the laminate, respectively. If pre-pressing is performed on the plurality of solid electrolyte membranes 10, a conduction path of lithium ions between the solid electrolyte membranes 10 may be well formed, and thus a required driving pressure of the all-solid-state battery may be decreased later. That is, even if the all-solid-state battery is charged and discharged in a pressurized state at a pressure of about 200 MPa to 400 MPa, the capacity is higher than that of the prior art.

Hereinafter, various examples of the present disclosure will be described in more detail through specific Examples. The following Examples are only examples to assist the understanding of the present disclosure, and the scope of the present disclosure is not limited thereto.

### Preparation Example 1

A slurry was prepared by adding a sulfide-based solid electrolyte and a monomer to hexyl butyrate which is a solvent. The monomer was trimethylolpropane ethoxylate triacrylate (ETPTA). The amount added was adjusted so that a weight ratio of the sulfide-based solid electrolyte to the monomer was about 97:3. The slurry included about 55% by weight of the sulfide-based solid electrolyte and monomer and about 45% by weight of the solvent.

The slurry was applied to one surface of a nonwoven fabric and dried at about 100° C. for about 20 minutes to form a coating layer. The coating layer was irradiated with ultraviolet rays to form a solid electrolyte layer.

A solid electrolyte layer was formed on the other surface of the nonwoven fabric in the same manner to complete the solid electrolyte membrane. The solid electrolyte membrane had a thickness of about 33 μm. The solid electrolyte membrane had a lithium ion conductivity of about 2.11×10⁻⁴ S/cm.

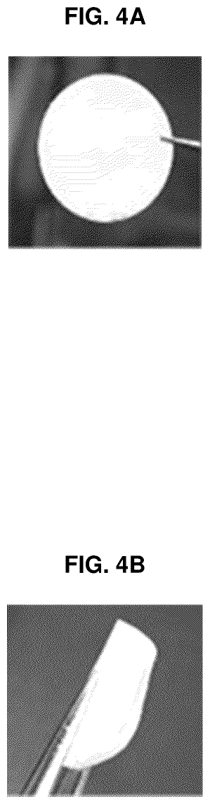

FIG. 4A shows a solid electrolyte membrane according to Preparation Example 1. FIG. 4B shows a result of 100 times of performing a folding test in which the solid electrolyte membrane according to Preparation Example 1 is folded at 180°. It can be seen that the solid electrolyte membrane according to Preparation Example 1 had a very smooth surface, and the solid electrolyte was not fallen off even after the folding test.

### Preparation Example 2

A solid electrolyte membrane was manufactured in the same manner as in Preparation Example 1, except that the amount added was adjusted so that the weight ratio of the sulfide-based solid electrolyte to the monomer was about 96:4. The solid electrolyte membrane had a thickness of about 33 μm. The solid electrolyte membrane had a lithium ion conductivity of about 1.29×10⁻⁴ S/cm.

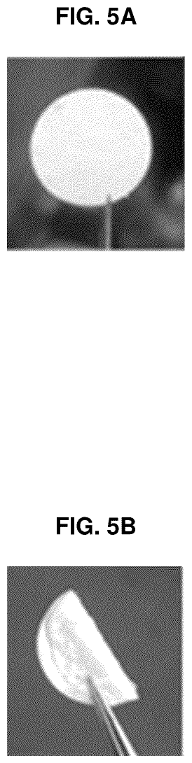

FIG. 5A shows a solid electrolyte membrane according to Preparation Example 2. FIG. 5B shows a result of 100 times of performing a folding test in which the solid electrolyte membrane according to Preparation Example 2 is folded at 180°. It can be seen that the solid electrolyte membrane according to Preparation Example 2 had a very smooth surface, and the solid electrolyte was not deintercalated even after the folding test.

### Example 1

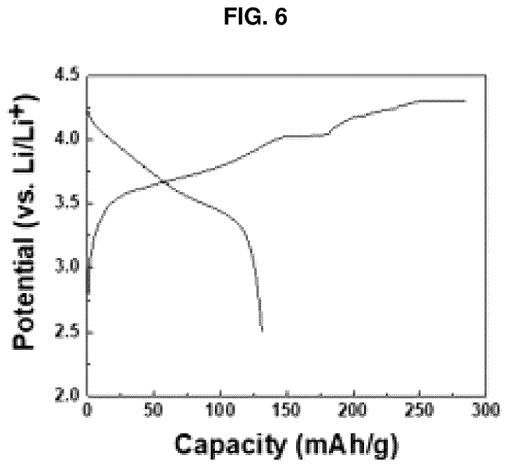

Three solid electrolyte membranes according to Preparation Example 1 were prepared. After laminating the solid electrolyte membranes, the laminate was prepared by pre-pressurization at about 75 MPa. A cathode and an anode were respectively attached to both surfaces of the laminate to complete an all-solid-state battery. The cathode included about 76% by weight of NCM711 as a cathode active material, and the anode included about 78% by weight of graphite as an anode active material. The all-solid-state battery was pressurized with a driving pressure of 300 MPa and charged and discharged under the condition of 0.05 C. FIG. 6 shows a result of charging and discharging the all-solid-state battery according to Example 1.

### Comparative Example 1

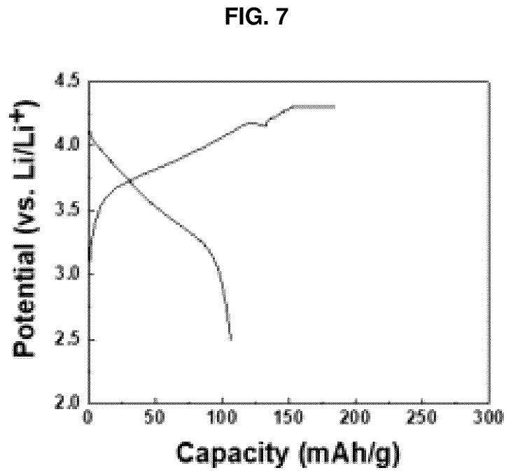

Three solid electrolyte membranes according to Preparation Example 1 were prepared. After laminating the solid electrolyte membranes, a cathode and an anode were respectively attached to both surfaces of the laminate without pre-pressurization to complete an all-solid-state battery. The all-solid-state battery was pressurized with a driving pressure of 450 MPa and charged and discharged. FIG. 7 shows a result of charging and discharging an all-solid-state battery according to Comparative Example 1.

### Comparative Example 2

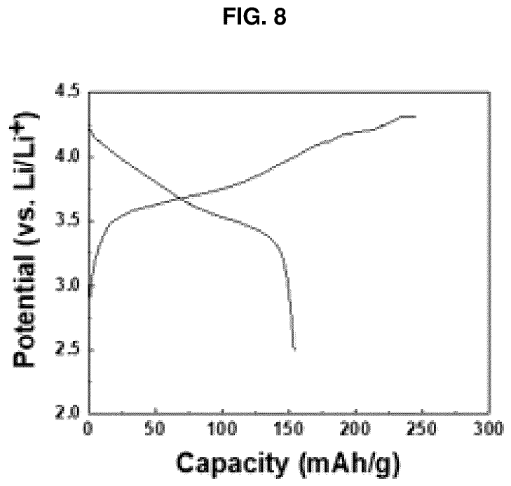

The same all-solid-state battery as in Example 1 was charged and discharged except that the driving pressure was increased to 450 MPa. FIG. 8 shows a result of charging and discharging an all-solid-state battery according to Comparative Example 2.

Referring to FIGS. 6 to 8, the capacities of Example 1, Comparative Example 1, and Comparative Example 2 were 154 mAh/g, 106 mAh/g, and 131 mAh/g, respectively. Example 1 showed the highest capacity, and Comparative Example 1, in which pre-pressurization was not applied, showed the lowest capacity. Comparative Example 2, in which the pre-pressurization was applied but the driving pressure was increased, showed a lower capacity than Example 1, because a micro short occurred due to the high driving pressure.

### Preparation Example 3

A slurry was prepared by adding a sulfide-based solid electrolyte and a monomer to hexyl butyrate as a solvent. The monomer was polyethylene glycol diacrylate (PEGDA). The amount added was adjusted so that a weight ratio of the sulfide-based solid electrolyte to the monomer was about 98:2. The slurry included about 55% by weight of the sulfide-based solid electrolyte and monomer and about 45% by weight of the solvent.

The slurry was applied to one surface of a nonwoven fabric and dried at about 100° C. for about 20 minutes to form a coating layer. The coating layer was irradiated with ultraviolet rays to form a solid electrolyte layer.

A solid electrolyte layer was formed on the other surface of the nonwoven fabric in the same manner to complete the solid electrolyte membrane. The solid electrolyte membrane had a thickness of about 29 μm. The solid electrolyte membrane had a lithium ion conductivity of about 3.29×10⁻⁴ S/cm.

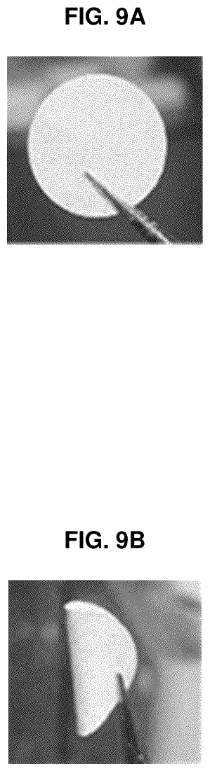

FIG. 9A shows a solid electrolyte membrane according to Preparation Example 3. FIG. 9B shows a result of 100 times of performing a folding test in which the solid electrolyte membrane according to Preparation Example 3 is folded at 180°. It can be seen that the solid electrolyte membrane according to Preparation Example 3 had a very smooth surface, and the solid electrolyte was not fallen off even after the folding test.

### Preparation Example 4

A solid electrolyte membrane was manufactured in the same manner as in Preparation Example 3, except that the amount added was adjusted so that the weight ratio of the sulfide-based solid electrolyte to the monomer was about 97:3. The solid electrolyte membrane had a thickness of about 30 μm. The solid electrolyte membrane had a lithium ion conductivity of about 2.54×10⁻⁴ S/cm.

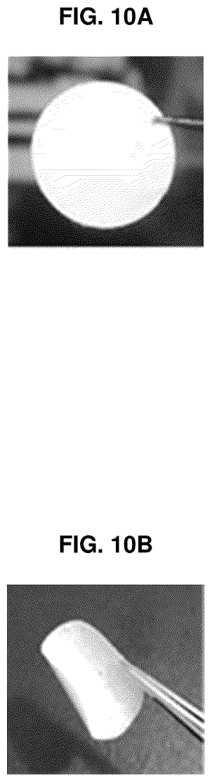

FIG. 10A shows a solid electrolyte membrane according to Preparation Example 4. FIG. 10B shows a result of 100 times of performing a folding test in which the solid electrolyte membrane according to Preparation Example 4 is folded at 180°. It can be seen that the solid electrolyte membrane according to Preparation Example 4 had a very smooth surface, and the solid electrolyte was not fallen off even after the folding test.

### Comparative Preparation Example

A solid electrolyte membrane was manufactured in the same manner as in Preparation Example 3, except that the amount added was adjusted so that the weight ratio of the sulfide-based solid electrolyte to the monomer was about 99:1. The solid electrolyte membrane had a thickness of about 31 μm.

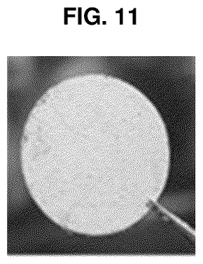

FIG. 11 shows a solid electrolyte membrane according to a Comparative Preparation Example. Even if the solid electrolyte membrane is visually observed, it can be seen that the surface was not smooth and the solid electrolyte was fallen off. Thus, the lithium ion conductivity of the solid electrolyte membrane was not measured.

### Example 2

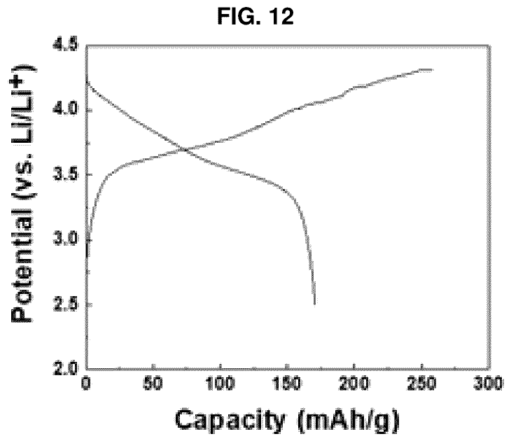

Three solid electrolyte membranes according to Preparation Example 3 were prepared. After laminating the solid electrolyte membranes, the laminate was prepared by pre-pressurization at about 75 MPa. A cathode and an anode were respectively attached to both surfaces of the laminate to complete an all-solid-state battery. The cathode included about 76% by weight of NCM711 as a cathode active material, and the anode included about 78% by weight of graphite as an anode active material. The all-solid-state battery was pressurized with a driving pressure of 300 MPa and charged and discharged under the condition of 0.05 C. FIG. 12 shows a result of charging and discharging an all-solid-state battery according to Example 2. Referring to FIG. 12, the capacity of the all-solid-state battery according to Example 2 was about 171 mAh/g, which was higher than that of Example 1 described above.

Although various examples of the present disclosure have been described with reference to the accompanying drawings, those skilled in the art will understand that the present disclosure can be implemented in other specific forms without changing the technical spirit or essential features. Therefore, it is to be understood that various examples described hereinabove are illustrative rather than being restrictive in all aspects.

What is claimed is:

1. A solid electrolyte membrane comprising:
a substrate comprising pores therein; and
a solid electrolyte layer disposed on at least one surface of the substrate and comprising a solid electrolyte and a cured compound,
wherein at least a portion of the solid electrolyte layer penetrates into the pores of the substrate and the solid electrolyte is filled in the pores of the substrate.

2. The solid electrolyte membrane of claim 1, wherein the solid electrolyte is filled in the substrate based on a thickness direction of the substrate to form a conduction path of lithium ions in the substrate.

3. The solid electrolyte membrane of claim 1, wherein the solid electrolyte comprises a sulfide-based solid electrolyte.

4. The solid electrolyte membrane of claim 1, wherein the cured compound is derived from a monomer comprising at least one of: a triacrylate-based monomer, a diacrylate-based monomer, a monoacrylate-based monomer, or any combination thereof.

5. The solid electrolyte membrane of claim 1, wherein the cured compound is derived from a monomer having a viscosity of about 20 cP to 100 cP.

6. The solid electrolyte membrane of claim 1, wherein the solid electrolyte layer comprises the solid electrolyte and the cured compound at a weight ratio of about 95:5 to 98:2.

7. The solid electrolyte membrane of claim 1, wherein the solid electrolyte membrane has a thickness in range of about 20 μm to 30 μm.

8. An all-solid-state battery comprising:
the solid electrolyte membrane of claim 1;
a cathode disposed on one surface of the solid electrolyte membrane; and
an anode disposed on another surface of the solid electrolyte membrane.

9. A manufacturing method comprising:
preparing a slurry comprising a solvent, a solid electrolyte, and a monomer;
forming a coating layer by applying and drying the slurry on at least one surface of a substrate comprising pores therein;
curing the coating layer to obtain a solid electrolyte membrane comprising the substrate and a solid electrolyte layer disposed on at least one surface of the substrate, wherein the solid electrolyte layer comprises the solid electrolyte and a cured compound; and
manufacturing an all-solid-state battery comprising the solid electrolyte membrane, a cathode disposed on one surface of the solid electrolyte membrane, and an anode disposed on another surface of the solid electrolyte membrane,
wherein at least a portion of the solid electrolyte layer penetrates into the pores of the substrate to form a conduction path of lithium ions in a thickness direction of the substrate.

10. The manufacturing method of claim 9, wherein the solvent has a vapor pressure of about 1 hPa or less.

11. The manufacturing method of claim 9, wherein the solvent comprises hexyl butyrate.

12. The manufacturing method of claim 9, wherein the solid electrolyte comprises a sulfide-based solid electrolyte.

13. The manufacturing method of claim 9, wherein the monomer comprises at least one of: a triacrylate-based monomer, a diacrylate-based monomer, a monoacrylate-based monomer, or any combination thereof.

14. The manufacturing method of claim 9, wherein the monomer has a viscosity of about cP to 100 cP.

15. The manufacturing method of claim 9, wherein the slurry comprises:
an amount of about 40% to 55% by weight of the solid electrolyte and the monomer; and
an amount of about 45% to 60% by weight of the solvent.

16. The manufacturing method of claim 9, wherein the coating layer is cured by irradiating ultraviolet rays.

17. The manufacturing method of claim 9, wherein the solid electrolyte layer comprises the solid electrolyte and the cured compound at a weight ratio of about 95:5 to 98:2.

18. The manufacturing method of claim 9, wherein the solid electrolyte membrane has a thickness in range of about 20 μm to 30 μm.

19. The manufacturing method of claim 9, wherein the manufacturing the all-solid-state battery comprises:
laminating a plurality of solid electrolyte membranes and pressurizing the plurality of solid electrolyte membranes at a pressure of about 50 MPa to 100 MPa to obtain a laminate, wherein the plurality of solid electrolyte membranes comprises the solid electrolyte membrane; and
attaching the cathode and the anode to both surfaces of the laminate, respectively.

20. The manufacturing method of claim 9, wherein the all-solid-state battery is configured to be charged and discharged in a pressurized state at a pressure of about 200 MPa to 400 MPa.
